(19) United States
(12) Patent Application Publication
(10) Pub. No.: US 2026/0246127 A1
(43) Pub. Date: Aug. 20, 2026

(54) PHASE SHIFTER, ANTENNA, AND COMMUNICATION BASE STATION

(71) Applicant: HUAWEI TECHNOLOGIES CO., LTD., Shenzhen (CN)

(72) Inventors: Haiqiang Sheng, Shanghai (CN); Tao Pu, Shanghai (CN); He Cui, Dongguan (CN); Jun Xu, Dongguan (CN); Wenfang Li, Dongguan (CN)

(73) Assignee: HUAWEI TECHNOLOGIES CO., LTD., Shenzhen (CN)

(21) Appl. No.: 19/655,936

(22) Filed: Apr. 23, 2026

Related U.S. Application Data
(63) Continuation of application No. PCT/CN2024/102916, filed on Jul. 1, 2024.

(30) Foreign Application Priority Data
Oct. 26, 2023 (CN) 202311402020.7

(51) Int. Cl. H01P 1/18; H01Q 1/24; H01Q 1/42; H01Q 3/36

(52) U.S. Cl. CPC H01P 1/184; H01Q 1/246; H01Q 1/42; H01Q 3/36

(57) ABSTRACT

This disclosure relates to the field of communication device technologies, and provide a phase shifter, an antenna, and a communication base station, to resolve problems of a high transmission loss and a large size of the phase shifter. The phase shifter includes a carrier board, a metal housing, a fastening medium, a sliding medium, and a metal feed plate. The carrier board includes a first metal layer disposed on one side. The metal housing is mounted on and fastened to a surface of the first metal layer, and is electrically connected to the first metal layer. The fastening medium is fastened and mounted in the metal housing, the metal housing and the fastening medium enclose a sliding cavity, and a relative permittivity of the fastening medium is greater than 1.

### CROSS-REFERENCE TO RELATED APPLICATIONS

This application is a continuation of International Application No. PCT/CN2024/102916, filed on Jul. 1, 2024, which claims priority to Chinese Patent Application No. 202311402020.7, filed on Oct. 26, 2023. The disclosures of the aforementioned applications are hereby incorporated by reference in their entireties.

### TECHNICAL FIELD

This disclosure relates to the field of communication device technologies, and in particular, to a phase shifter, an antenna, and a communication base station.

### BACKGROUND

With the development of communication technologies, a MIMO (multiple-input multiple-output) technology is used to improve channel capacities and network speeds. As a result, larger antenna arrays, more antenna elements, and more complex antenna feed circuits are needed for antennas in communication base stations. In addition, higher power is needed to improve coverage of antenna beams and signal quality.

As a key component in an antenna feed circuit, a phase shifter is configured to adjust a transmission phase of the antenna feed circuit, to control beamforming of an antenna array. A size and a transmission loss of the phase shifter affect sizes and transmission losses of an antenna and a base station. However, a phase shifter in a related technology has problems of a high transmission loss and a large size.

### SUMMARY

Embodiments of this disclosure provide a phase shifter, an antenna, and a communication base station, to resolve problems of a high transmission loss and a large size of the phase shifter.

To achieve the foregoing objective, the following technical solutions are used in embodiments of this disclosure.

According to a first aspect, an embodiment of this disclosure provides a phase shifter, where the phase shifter includes a carrier board, a metal housing, a fastening medium, a sliding medium, and a metal feed plate. The carrier board includes a first metal layer disposed on one side. The metal housing is mounted on and fastened to a surface of the first metal layer, and is electrically connected to the first metal layer.

The fastening medium is fastened and mounted in the metal housing, the metal housing and the fastening medium enclose a sliding cavity, and a relative permittivity of the fastening medium is greater than 1. The sliding medium is disposed in the sliding cavity, the sliding medium located in the sliding cavity is slidable relative to the fastening medium, and the sliding medium is provided with a sliding slot whose opening faces the fastening medium. The metal feed plate is mounted on the fastening medium and includes a phase-shift circuit extending into the sliding slot.

In the phase shifter provided in this embodiment of this disclosure, the sliding medium, the metal housing, the metal feed plate, and the fastening medium jointly form a stripline structure, which has an advantage of a small insertion loss compared with a PCB microstrip in a related technology, and is conducive to reducing a transmission loss of the phase shifter. In addition, the fastening medium has a high relative permittivity, which is conducive to reducing a size of the phase shifter. In addition, the metal housing is fastened to the carrier board in a mounting manner, so that a connection structure and a connection manner can be simplified. This helps reduce the size of the phase shifter, and further facilitates miniaturization of the phase shifter.

In some embodiments, the metal housing is mounted on and fastened to the first metal layer through soldering or by using conductive adhesive. Different mounting and fastening manners can be applied to the phase shifter provided in this embodiment of this disclosure, and a mounting operation is simple and easy to implement. This is conducive to reducing assembly difficulty and assembly costs of the phase shifter.

In some embodiments, the metal housing is provided with a positioning pin protruding toward the carrier board; the carrier board is provided with a positioning hole that fits the positioning pin; and when the metal housing is mounted on and fastened to the first metal layer, the positioning pin extends into the positioning hole. Through fitting between the positioning pin and the positioning hole, accuracy of a relative position between the metal housing and the first metal layer can be ensured in a process in which the metal housing is mounted on and fastened to the first metal layer and after mounting and fastening.

In some embodiments, a portion that is of the metal housing and that is in contact with the first metal layer includes a plurality of connection portions that are spaced apart and overflow notches located at edges of the connection portions, and the connection portions are mounted on and fastened to the first metal layer. The plurality of connection portions that are spaced apart are provided, which is conducive to ensuring connection reliability and reducing a connection area, and is therefore conducive to reducing costs. The overflow notch is provided, so that impact, on another structure, of overflow of mounting materials (for example, solder paste and conductive adhesive) located between the connection portion and the first metal layer can be avoided.

In some embodiments, the metal housing includes a connection plate, a first side plate, and a second side plate, and the first side plate and the second side plate are disposed opposite to each other on a same side of the connection plate, and are separately connected to the connection plate.

The fastening medium is located between the first side plate and the second side plate, and the first side plate and the second side plate are respectively connected to two side surfaces of the fastening medium.

In the phase shifter provided in this embodiment of this disclosure, the metal housing is of a U-shaped structure, the fastening medium is mounted in an accommodating cavity of the U-shaped structure, and the metal housing and the fastening medium enclose the sliding cavity. The structure is simple and easy to assemble, and occupies a small volume.

In some embodiments, an outer side surface of the first side plate or an outer side surface of the second side plate is mounted on and fastened to the first metal layer; or an outer side surface of the connection plate is mounted on and fastened to the first metal layer; or end surfaces that are of the first side plate and the second side plate and that are away from the connection plate are mounted on and fastened to the first metal layer.

In the phase shifter provided in this embodiment of this disclosure, the metal housing and the first metal layer may use a plurality of different mounting manners, so that mounting is flexible and has good adaptability, and can be applied to different disclosure scenarios.

In some embodiments, the end surfaces that are of the first side plate and the second side plate and that are away from the connection plate are mounted on and fastened to the first metal layer.

The first side plate and the second side plate each include a side plate end that is away from the connection plate, the side end portion includes a positioning pin protruding toward the carrier board, and the carrier board is provided with a positioning hole that fits the positioning pin. When the metal housing is mounted on and fastened to the first metal layer, the positioning pin extends into the positioning hole. Through fitting between the positioning pin and the positioning hole, accuracy of the relative position between the metal housing and the first metal layer can be ensured in the process in which the metal housing is mounted on and fastened to the first metal layer and after mounting and fastening.

In some embodiments, the end surfaces that are of the first side plate and the second side plate and that are away from the connection plate are mounted on and fastened to the first metal layer.

The first side plate and the second side plate each include the side plate end that is away from the connection plate, the side plate end includes a plurality of connection portions that are spaced apart in a length direction, and the connection portions are mounted on and fastened to the first metal layer. The side plate end further includes overflow notches located at edges of the connection portions in the length direction.

The plurality of connection portions that are spaced apart are provided, which is conducive to ensuring connection reliability and reducing the connection area, and is therefore conducive to reducing costs. The overflow notch is provided, so that impact, on another structure, of overflow of the mounting materials (for example, solder paste and conductive adhesive) located between the connection portion and the first metal layer can be avoided.

In some embodiments, the first side plate and the second side plate further include limiting openings, the limiting openings run through the end surfaces that are of the first side plate and the second side plate and that are away from the connection plate, and the fastening medium is provided with limiting protrusions. When the fastening medium is connected to the metal housing, the limiting protrusion extends into the limiting opening. In the phase shifter provided in this embodiment of this disclosure, limiting and fastening of the metal housing and the fastening medium are implemented through fitting between the limiting opening and the limiting protrusion. A structure is simple, and no additional connection apparatus is required, which is conducive to reducing the size of the phase shifter.

In some embodiments, the metal housing further includes an opening baffle, and the opening baffle is disposed opposite to the connection plate, and is connected to both the first side plate and the second side plate. The fastening medium is located on a side that is of the opening baffle and that is close to the connection plate. The opening baffle is disposed, so that the metal housing forms a closed enclosure structure. This is conducive to improving stability and reliability of the metal housing, and is conducive to forming a shielding cavity with better shielding effect.

In some embodiments, the metal housing further includes a partition plate connected to the connection plate, and the partition plate is located between the first side plate and the second side plate, and is parallel to the first side plate and the second side plate.

The fastening medium includes a first fastening medium and a second fastening medium respectively located on two sides of the partition plate.

The sliding cavity includes a first sliding cavity enclosed by the first fastening medium and the metal housing, and a second sliding cavity enclosed by the second fastening medium and the metal housing.

The sliding medium includes a first sliding medium and a second sliding medium that are respectively located in the first sliding cavity and the second sliding cavity. The first sliding medium located in the first sliding cavity is slidable relative to the first fastening medium, and the second sliding medium located in the second sliding cavity is slidable relative to the second fastening medium. The first sliding medium is provided with a first sliding slot whose opening faces the first fastening medium, and the second sliding medium is provided with a second sliding slot whose opening faces the second fastening medium.

The metal feed plate includes a first circuit portion and a second circuit portion that are respectively located on the two sides of the partition plate. The first circuit portion is mounted on the first fastening medium and includes a phase-shift circuit extending into the first sliding slot, and the second circuit portion is mounted on the second fastening medium and includes a phase-shift circuit extending into the second sliding slot.

The phase shifter provided in this embodiment of this disclosure may have two or more accommodating cavities, and a stripline structure may be formed in each accommodating cavities. This is conducive to integrating more phase-shift circuits and forming a more complex antenna feed circuit, and is conducive to improving integration of the phase shifter.

In some embodiments, the metal feed plate further includes an intercavity circuit portion that connects the first circuit portion and the second circuit portion, and the partition plate is provided with an intercavity window that allows the intercavity circuit portion to pass through. In the phase shifter provided in this embodiment of this disclosure, circuit portions located in different accommodating cavities may be interconnected. This is conducive to forming a more complex antenna feed circuit, and is conducive to improving integration of the phase shifter.

In some embodiments, the first circuit portion includes at least two phase-shift circuits extending into the first sliding slot; and/or the second circuit portion includes at least two phase-shift circuits extending into the second sliding slot. In the phase shifter provided in this embodiment of this disclosure, more than one phase-shift circuit may be disposed in the accommodating cavity. This is conducive to forming a more complex antenna feed circuit, and is conducive to improving integration of the phase shifter.

In some embodiments, the metal feed plate includes the phase-shift circuit and a power division circuit. Such a design is conducive to forming a more complex antenna feed circuit, and is conducive to improving integration of the phase shifter.

In some embodiments, the metal feed plate includes a connection pin, and the connection pin is electrically connected to a second metal layer on the carrier board; or the connection pin is suspended relative to the carrier board. When the connection pin is suspended relative to the carrier board, the connection pin may be directly connected to the connection component, so that transfer performed by the carrier board or a cable is omitted, which is conducive to reducing the transmission loss.

In some embodiments, the metal feed plate is a sheet metal stripline. Such a design can reduce processing difficulty and processing costs of the metal feed plate.

In some embodiments, the metal housing is a sheet metal mechanical part. Such a design can reduce processing difficulty and processing costs of the metal housing, is conducive to reducing a thickness and an occupied volume of the metal housing, and facilitates miniaturization of the phase shifter.

According to a second aspect, an embodiment of this disclosure further provides an antenna. The antenna includes an antenna element and the phase shifter according to the embodiment of the first aspect, where the antenna element is electrically connected to the phase shifter.

According to a third aspect, an embodiment of this disclosure further provides a communication base station. The communication substrate includes the antenna according to the embodiment of the second aspect and main equipment of a base station, where the main equipment of the base station is electrically connected to the antenna.

Technical effects that can be achieved by the antenna and the communication base station provided in embodiments of this disclosure are the same as technical effects that can be achieved by the phase shifter in any one of the foregoing embodiments. Details are not described herein again.

### BRIEF DESCRIPTION OF DRAWINGS

FIG. 1 is a diagram of a structure of a phase shifter according to an embodiment of this disclosure;

FIG. 2 is an exploded view of the phase shifter in FIG. 1;

FIG. 3 is a diagram of a structure of a metal housing in FIG. 1 and FIG. 2;

FIG. 4 is a diagram of a structure of the metal housing in FIG. 3 from another angle;

FIG. 5 is a diagram of a structure of a metal feed plate in FIG. 1 and FIG. 2;

FIG. 6 is a diagram of a structure of the metal feed plate in FIG. 5 from another angle;

FIG. 7 is a diagram of a structure of a fastening medium in FIG. 1 and FIG. 2;

FIG. 8 is a diagram of a structure of a metal housing, a metal feed plate, and a fastening structure in FIG. 1 and FIG. 2;

FIG. 9 is a diagram of a structure of a sliding medium in FIG. 1 and FIG. 2;

FIG. 10 is a diagram of a structure of another phase shifter according to an embodiment of this disclosure;

FIG. 11 is a diagram of a structure of still another phase shifter according to an embodiment of this disclosure;

FIG. 12 is a diagram of a structure of still another phase shifter according to an embodiment of this disclosure;

FIG. 13 is a diagram of a structure of an antenna according to an embodiment of this disclosure; and

FIG. 14 is a diagram of a structure of a communication base station according to an embodiment of this disclosure.

### DETAILED DESCRIPTION

The following describes the technical solutions in embodiments of this disclosure with reference to the accompanying drawings in embodiments of this disclosure. It is clear that the described embodiments are merely some but not all of embodiments of this disclosure.

Terms such as “first” and “second” mentioned below in embodiments of this disclosure are merely used for ease of description, and shall not be understood as an indication or implication of relative importance or implicit indication of a quantity of indicated technical features. Therefore, a feature limited by “first”, “second”, or the like may explicitly or implicitly include one or more features. In the descriptions of this disclosure, unless otherwise stated, “a plurality of” means two or more than two.

In embodiments of this disclosure, “up”, “down”, “left”, and “right” are not limited to orientations of schematically placed components in relative accompanying drawings. It should be understood that these orientation terms may be relative concepts. The orientation terms are used for relative description and clarification, and may vary correspondingly based on a change in an orientation in which the component is placed in the accompanying drawings.

In embodiments of this disclosure, unless otherwise specified in the context, in the entire specification and claims, the term “include” is interpreted as “open and inclusive”, that is, “include, but not limited to”. In the description of this specification, terms such as “an embodiment”, “some embodiments”, “an example embodiment”, “an example”, or “some examples” are intended to indicate that a specific feature, structure, material, or characteristic related to embodiments or examples are included in at least one embodiment or example of this disclosure. The schematic representations of the foregoing terms do not necessarily mean a same embodiment or example. Further, the particular feature, structure, material, or characteristic may be included in any one or more embodiments or examples in any appropriate manner.

As used in this specification, “about”, “general”, or “approximate” includes the stated values and the average values within an acceptable deviation range of a particular value, where the acceptable deviation range is determined by a person of ordinary skill in the art by considering an error (e.g., a limitation of a measurement system) related to measurement being discussed and measurement of a specific quantity.

As used in this specification, “parallel”, “perpendicular to”, and “equal to” include described cases and similar cases. A range of a similar case is in an acceptable deviation range, where the acceptable deviation range is determined by a person of ordinary skill in the art by considering an error (e.g., a limitation of a measurement system) related to measurement being discussed and measurement of a specific quantity. For example, “parallel” includes “absolutely parallel” and “approximately parallel”, and an acceptable deviation range of “approximately parallel” may be, for example, a deviation within 5°. “Perpendicular to” includes “absolutely perpendicular to” and “approximately perpendicular to”, and an acceptable deviation range of “approximately perpendicular to” may also be, for example, a deviation within 5°. “Equal to” includes “absolutely equal to” and “approximately equal to”. An acceptable deviation range of “approximately equal to” may be that, for example, a difference between two equal objects is less than or equal to 5% of either of the two objects.

It should be understood that, when a layer or an element is referred to as on another layer or substrate, the layer or element may be directly on the other layer or substrate, or an intermediate layer may exist between the layer or element and the other layer or substrate.

An example embodiment is described with reference to a sectional view and/or a plane diagram and/or an equivalent circuit diagram that are/is used as idealized example accompanying drawings. In the accompanying drawings, for clarity, thicknesses of layers and regions are enlarged. Therefore, a change in a shape in the accompanying drawings due to, for example, manufacturing techniques and/or tolerances may be envisaged. Therefore, example embodiments should not be construed as being limited to a shape of a region shown herein, but rather include shape deviations due to, for example, manufacturing. For example, an etching region shown as a rectangle typically has a bending characteristic. Therefore, the regions shown in the accompanying drawings are essentially examples, and their shapes are not intended to show actual shapes of regions of a device, and are not intended to limit a scope of the example embodiments.

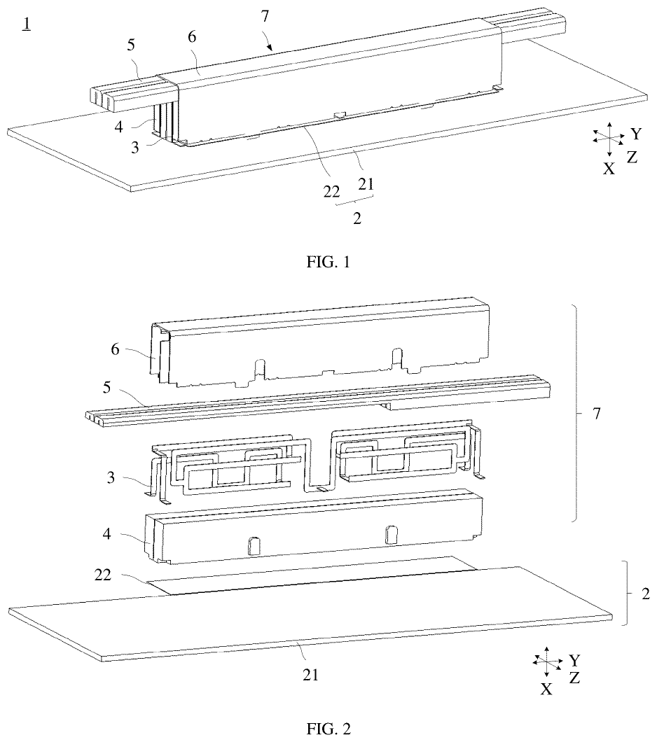

An embodiment of this disclosure provides a phase shifter 1. As shown in FIG. 1 and FIG. 2, the phase shifter 1 includes a carrier board 2 and a mounting assembly 7 fastened to and installed on the carrier board 2. The carrier board 2 may be any board structure that can carry a circuit or a component, for example, a printed circuit board (PCB) or a plastic plate. A first metal layer 22 configured to connect to the mounting assembly 7 is disposed on one side of the carrier board 2.

In this embodiment, as shown in FIG. 1 and FIG. 2, the carrier board 2 includes a substrate 21 and the first metal layer 22. The substrate 21 is a plate structure whose thickness direction is parallel to a first direction X. The plate structure includes a first surface and a second surface that are provided opposite to each other in the first direction X. The first surface and the second surface are both parallel to a second direction Y and a third direction Z. The first direction X, the second direction Y, and the third direction Z may be perpendicular to each other. In the orientation shown in FIG. 2, the first direction X is a longitudinal direction, and the first surface is located above the second surface. That is, the first surface is an upper surface of the substrate 21, and the second surface is a lower surface of the carrier board 2. In the carrier board 2, the first metal layer 22 is disposed on the first surface of the substrate 21.

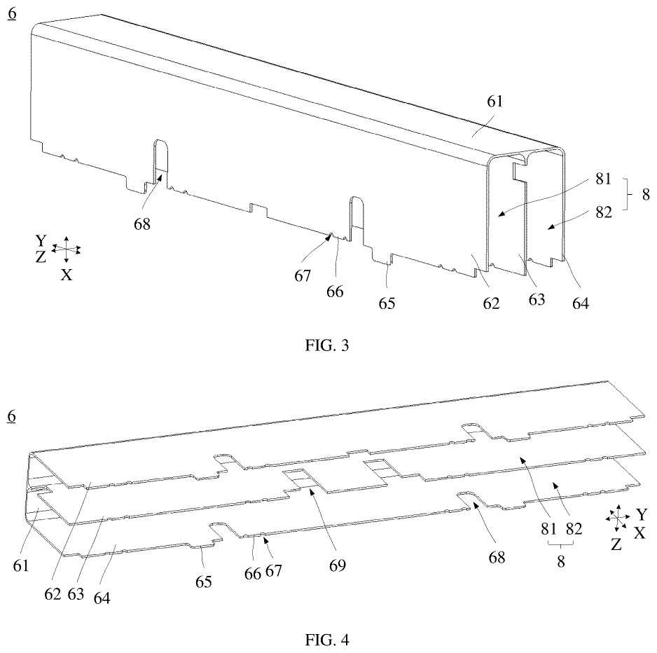

Still refer to FIG. 1 and FIG. 2. The mounting assembly 7 is fastened to and installed on the carrier board 2, and the mounting assembly 7 includes a metal housing 6, a fastening medium 4, a sliding medium 5, and a metal feed plate 3. As shown in FIG. 3 and FIG. 4, the metal housing 6 includes a connection plate 61, a first side plate 62, a second side plate 64, and a partition plate 63. The first side plate 62, the second side plate 64, and the partition plate 63 are all disposed on one side of the connection plate 61. For example, the first side plate 62, the second side plate 64, and the partition plate 63 are all perpendicularly connected to the connection plate 61.

The first side plate 62 and the second side plate 64 may be of a same plate structure, and are disposed opposite to each other. The first side plate 62 and the second side plate 64 that are disposed opposite to each other may be respectively connected to two opposite sides of the connection plate 61. The first side plate 62, the second side plate 64, and the connection plate 61 form a U-shaped structure, and the U-shaped structure encloses an accommodating cavity 8. The partition plate 63 is a plate structure parallel to the first side plate 62 and the second side plate 64. The plate structure is disposed between the first side plate 62 and the second side plate 64, and divides the accommodating cavity 8 into two parts. The accommodating cavity 8 is divided by the partition plate 63 into a first accommodating cavity 81 and a second accommodating cavity 82 that are respectively located on two sides of the partition plate 63.

The metal housing 6 may be a sheet metal mechanical part formed by a profile through a sheet metal process. Such a design can reduce a thickness of the metal housing 6, so that it is easier to miniaturize the phase shifter 1. In addition, processing difficulty of the metal housing 6 can be further reduced and processing efficiency of the metal housing 6 can be further improved through the sheet metal process.

In the phase shifter 1 provided in this embodiment of this disclosure, the metal housing 6 is mounted on and fastened to the first metal layer 22, so that the mounting assembly 7 is fastened to and installed on the carrier board 2. The metal housing 6 and the first metal layer 22 may be further electrically connected through mounting and fastening.

In this embodiment, the metal housing 6 is mounted on and fastened to the first metal layer 22 through soldering of the first metal layer 22 and end surfaces of the first side plate 62 and the second side plate 64. That is, the first side plate 62 and the second side plate 64 include side plate ends that are away from the connection plate 61. When the metal housing 6 is mounted on and fastened to the first metal layer 22 on the carrier board 2, the end surfaces of the side plate ends are attached to the first metal layer 22, and through an SMT (surface mounted technology) process, the metal housing 6 is soldered and fastened to the first metal layer 22, and the metal housing 6 is electrically connected to the first metal layer 22. The SMT process includes: The first metal layer 22 is coated with solder paste, the end surfaces of the side plate ends are attached to a surface of the first metal layer 22, and then the metal housing 6 is mounted on and fastened to the first metal layer 22 in a reflow soldering manner.

As shown in FIG. 1, after the metal housing 6 is mounted on and fastened to the first metal layer 22, the connection plate 61 in the metal housing 6 is parallel to the carrier board 2, that is, is a plate structure parallel to the second direction Y and the third direction Z. The first side plate 62, the second side plate 64, and the partition plate 63 are all perpendicularly connected to the carrier board 2, that is, are all plate structures parallel to the first direction X and the second direction Y. In addition, the first side plate 62, the partition plate 63, and the second side plate 64 are spaced apart in the third direction Z. An opening of the U-shaped structure formed by the first side plate 62, the second side plate 64, and the connection plate 61 faces the carrier board 2. The accommodating cavity 8, the first accommodating cavity 81, and the second accommodating cavity 82 are all cavity structures that run through the metal housing 6 in the second direction Y.

As shown in FIG. 3 and FIG. 4, in this embodiment, the side plate end includes a plurality of connection portions 66 that are spaced apart in a length direction. It should be noted that the length direction of the side plate end herein is a length direction of the first side plate 62 and the second side plate 64, that is, a direction parallel to the second direction Y. When the side plate end is in contact with the first metal layer 22, the metal housing 6 may be mounted on and fastened to the carrier board 2 through soldering of the connection portions 66 and the first metal layer 22. The plurality of connection portions 66 that are spaced apart are provided, so that discontinuous connection between the metal housing 6 and the first metal layer 22 can be implemented. In this way, reliability of connection between the metal housing 6 and the carrier board 2 is ensured, and a soldering area is reduced, which is conducive to reducing costs.

The side plate end may further include overflow notches 67 located at edges of the connection portions 66 in the length direction (parallel to the second direction Y). The overflow notch 67 is provided, so that the connection portion 66 can be separated from another structure on the side plate end, to prevent soldering tin from overflowing to another portion at a bottom of the metal housing 6 during soldering. When a contact area between the connection portion 66 and the first metal layer 22 is large, or when the end surface of the side plate end is entirely soldered to the first metal layer 22, a soldering tin overflow situation is improved. Therefore, the overflow notch 67 may not be provided.

In some embodiments, the side plate end further includes a positioning pin 65 extending toward the carrier board 2, and the positioning pin 65 protrudes from the end surface. The carrier board 2 is provided with a positioning hole that fits the positioning pin 65. When the metal housing 6 is mounted on and fastened to the carrier board 2, the positioning pin 65 extends into the positioning hole, and a relative position between the carrier board 2 and the metal housing 6 is limited through fitting between the positioning pin 65 and the positioning hole. In this way, accuracy and reliability of the relative position between the metal housing 6 and the carrier board 2 can be ensured in a process in which the metal housing 6 is mounted on and fastened to the carrier board 2 and after the process is completed.

The foregoing structures, for example, the connection portion 66, the overflow notch 67, and the positioning pin 65, of the metal housing 6 at the side plate end, may be formed by stamping the first side plate 62 and the second side plate 64. In such a design, processing difficulty of the metal housing 6 can be reduced, and an integrally formed structure can be implemented.

In some embodiments, the metal housing 6 may further include an opening baffle. The opening baffle is disposed opposite to the connection plate 61, and is connected to both the first side plate 62 and the second side plate 64. The opening baffle is disposed, so that a closed enclosure structure can be formed. This is conducive to fastening of the mounting assembly 7 and forming a shielding cavity with better shielding effect.

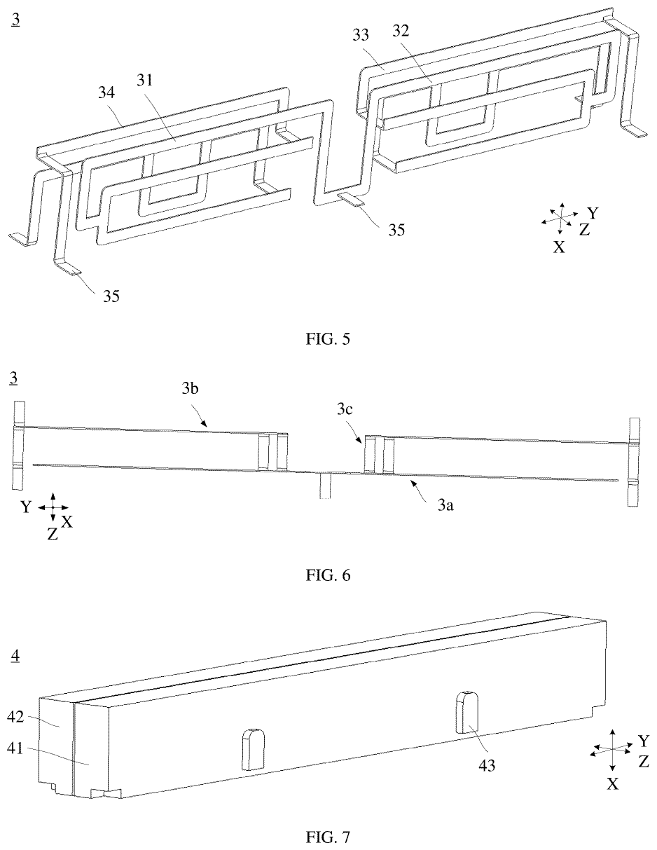

Still refer to FIG. 1 and FIG. 2. The fastening medium 4, the sliding medium 5, and the metal feed plate 3 are mounted in the accommodating cavity 8 enclosed by the metal housing 6. As shown in FIG. 5 and FIG. 6, the metal feed plate 3 may be a sheet metal stripline formed through a sheet metal bending process, and the sheet metal stripline forms an antenna feed circuit through a winding design. The antenna feed circuit may include two or more phase-shift circuits, and may further include a power division circuit configured to implement power distribution. The metal feed plate 3 further includes a connection pin 35 configured to implement input and output of the antenna feed circuit. The connection pin 35 may include a radio frequency input pin and a radio frequency output pin. A quantity of radio frequency input pins and a quantity of radio frequency output pins may be determined based on a design of the antenna feed circuit.

As shown in FIG. 1 and FIG. 2, after the mounting assembly 7 is assembled with the carrier board 2, the connection pin 35 in the metal feed plate 3 may be electrically connected to a second metal layer disposed on the carrier board 2, where the second metal layer is integrated with a circuit for transferring the connection pin 35.

Refer to FIG. 5 and FIG. 6. In this embodiment, the metal feed plate 3 includes a first circuit portion 3a, a second circuit portion 3b, and an intercavity circuit portion 3c. The first circuit portion 3a and the second circuit portion 3b are respectively located on the two sides of the partition plate 63, that is, respectively located in the first accommodating cavity 81 and the second accommodating cavity 82. At least one phase-shift circuit may be disposed in each of the first circuit portion 3a and the second circuit portion 3b.

The intercavity circuit portion 3c includes a sheet metal stripline segment configured to electrically connect the first circuit portion 3a and the second circuit portion 3b. The sheet metal stripline segment may electrically connect, based on the design of the antenna feed circuit, the first circuit portion 3a and the second circuit portion 3b that are respectively located in the first accommodating cavity 81 and the second accommodating cavity 82. Correspondingly, as shown in FIG. 4, the partition plate 63 of the metal housing 6 is provided with an intercavity window 69 that allows the intercavity circuit portion 3c to pass through.

For example, as shown in FIG. 5 and FIG. 6, the first circuit portion 3a includes a first phase-shift segment 31 and a second phase-shift segment 32 that are arranged in the second direction Y, and the first phase-shift segment 31 and the second phase-shift segment 32 each are a sheet metal stripline segment extending a specific length in the second direction Y. The second circuit portion 3b includes a third phase-shift segment 33 and a fourth phase-shift segment 34 that are arranged in the second direction Y, and the third phase-shift segment 33 and the fourth phase-shift segment 34 each are a sheet metal stripline segment extending a specific length in the second direction Y. In the metal feed plate 3, the first phase-shift segment 31, the second phase-shift segment 32, the third phase-shift segment 33, and the fourth phase-shift segment 34 respectively belong to four different phase-shift circuits.

The metal feed plate 3 further includes a T-junction configured to implement a power distribution function, one radio frequency input pin, and four radio frequency output pins.

In some other embodiments, the first circuit portion 3a and/or the second circuit portion 3b may include only one phase-shift circuit, or include a plurality of phase-shift circuits arranged in the second direction Y. A specific quantity of phase-shift circuits may be determined based on the design of the antenna feed circuit.

In some other embodiments, the metal feed plate 3 may alternatively include only the phase-shift circuit, and does not include the power division circuit.

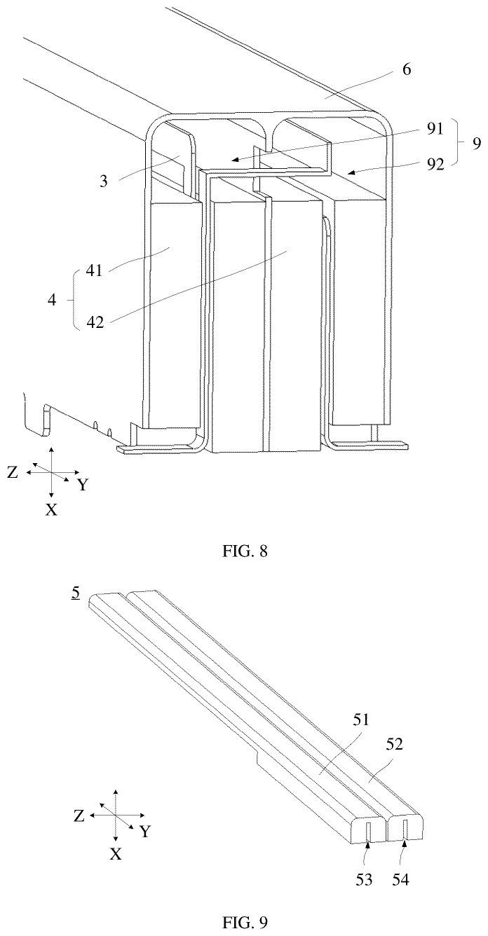

Refer to FIG. 1, FIG. 2, FIG. 7, and FIG. 8. The fastening medium 4 is disposed between the first side plate 62 and the second side plate 64, and is located at an end cavity portion that is of the accommodating cavity 8 and that is away from the connection plate 61. The first side plate 62 and the second side plate 64 are respectively in contact with two side surfaces of the fastening medium 4 in the second direction Y. The fastening medium 4 and the connection plate 61, the first side plate 62, and the second side plate 64 in the metal housing 6 enclose a sliding cavity 9, and the sliding cavity 9 runs through the metal housing 6 in the second direction Y.

In an embodiment in which the metal housing 6 has the opening baffle, the fastening medium 4 is located on a side that is of the opening baffle and that is close to the connection plate 61.

The fastening medium 4 is provided with an installation slot configured for installing the metal feed plate 3, a part of a winding of the metal feed plate 3 extends in the installation slot, and the connection pin 35 in the metal feed plate 3 may be formed by bending the sheet metal stripline in the installation slot. In this embodiment, a pin notch that runs through the installation slot is provided at a bottom that is of the fastening medium 4 and that is away from the connection plate 61, and the connection pin 35 is formed by bending the sheet metal stripline in the installation slot toward the pin notch. When the mounting assembly 7 is fastened to and installed on the carrier board 2, the connection pin 35 may be in contact with the carrier board 2, and is electrically connected to the second metal layer disposed on the carrier board 2.

A part of the winding of the metal feed plate 3 is further located outside the fastening medium 4, and extends into the sliding cavity 9. The metal feed plate 3 located in the sliding cavity 9 includes the phase-shift circuit. The fastening medium 4 is made of a material whose relative permittivity is greater than 1, for example, plastic or ceramic. The fastening medium 4 is disposed, so that a relative permittivity of a medium filled in the accommodating cavity 8 can be increased. This can shorten a winding length of the metal feed plate 3 and reduce a size of the phase shifter 1, and further improves integration of the phase shifter 1 and facilitates miniaturization of the phase shifter 1.

To implement reliability of connection between the metal housing 6 and the fastening medium 4, a relative position between the metal housing 6 and the fastening medium 4 needs to be fastened. Fastening of the relative position between the metal housing 6 and the fastening medium 4 may be implemented through an interference fit between the metal housing 6 and the fastening medium 4, or may be implemented by bonding the metal housing 6 and the fastening medium 4 in a contact region by using connection adhesive, or may be implemented by using a limiting structure. The limiting structure may include a limiting protrusion 43 provided on the fastening medium 4 and a limiting opening 68 provided on the metal housing 6. When the fastening medium 4 is connected to the metal housing 6, the limiting protrusion 43 extends into the limiting opening 68, and the relative position of the fastening medium 4 and the metal housing 6 is limited through fitting between the limiting protrusion 43 and the limiting opening 68.

In this embodiment, as shown in FIG. 7 and FIG. 8, the fastening medium 4 includes a first fastening medium 41 and a second fastening medium 42 that are respectively disposed on the two sides of the partition plate 63. That is, the first fastening medium 41 and the second fastening medium 42 are respectively located in the first accommodating cavity 81 and the second accommodating cavity 82. The first fastening medium 41, the first side plate 62, the partition plate 63, and the connection plate 61 enclose a first sliding cavity 91 extending in the second direction Y, and the second fastening medium 42, the second side plate 64, the partition plate 63, and the connection plate 61 enclose a second sliding cavity 92. In other words, the sliding cavity 9 is divided by the partition plate 63 into the first sliding cavity 91 and the second sliding cavity 92. The first phase-shift segment 31 and the second phase-shift segment 32 in the metal feed plate 3 are located in the first sliding cavity 91, and the third phase-shift segment 33 and the fourth phase-shift segment 34 in the metal feed plate 3 are located in the second sliding cavity 92.

An outer side surface that is of the first fastening medium 41 and that is away from the second fastening medium 42 is provided with a first limiting protrusion, the first side plate 62 is provided with a first limiting opening that fits the first limiting protrusion, and the first limiting opening runs through, in the first direction X, the end surface that is of the first side plate 62 and that is away from the connection plate 61. An outer side surface that is of the second fastening medium 42 and that is away from the first fastening medium 41 is provided with a second limiting protrusion, the second side plate 64 is provided with a second limiting opening that fits the second limiting protrusion, and the second limiting opening runs through, in the first direction X, the end surface that is of the second side plate 64 and that is away from the connection plate 61. When the metal housing 6 is assembled with the fastening medium 4, the metal housing 6 may fit the fastening medium 4 in the first direction X. The first limiting protrusion is inserted into the first limiting opening, and the second limiting protrusion is inserted into the second limiting opening, to implement limiting fitting between the fastening medium 4 and the metal housing 6.

Refer to FIG. 1, FIG. 2, and FIG. 9. The sliding medium 5 is disposed in the sliding cavity 9, and is a rod structure in contact with the fastening medium 4. The rod structure extends in the second direction Y, and extends out of at least one end of the sliding cavity 9. Under contact support of the fastening medium 4, the sliding medium 5 can slide in the sliding cavity 9 in the second direction Y. The sliding medium 5 is provided, on a side close to the fastening medium 4, with a sliding slot whose opening faces the fastening medium 4. The sliding slot extends a specific length in the second direction Y, and the phase-shift circuit located in the sliding cavity 9 extends into the sliding slot. In a process in which the sliding medium 5 moves in the second direction Y, the sliding medium 5 covered on the phase-shift circuit may be changed, to implement a phase shift function.

It can be seen from the foregoing descriptions that the fastening medium 4 has a plurality of functions. The fastening medium 4 can be connected to the metal housing 6 to form the sliding cavity 9 that allows the sliding medium 5 to slide. Also, the fastening medium 4 can fasten the metal feed plate 3, and can shorten the winding length of the metal feed plate 3 by increasing the relative permittivity. In addition, the fastening medium 4 can implement contact support for the sliding medium 5, and provide a structural basis for sliding of the sliding medium 5.

Refer to FIG. 9. In this embodiment, the sliding medium 5 includes a first sliding medium 51 and a second sliding medium 52 that are located on the two sides of the partition plate 63, where the first sliding medium 51 includes a first sliding slot 53, and both the first phase-shift segment 31 and the second phase-shift segment 32 are located in the first sliding slot 53. The second sliding medium 52 is provided with a second sliding slot 54, and both the third phase-shift segment 33 and the fourth phase-shift segment 34 are located in the second sliding slot 54. The first sliding medium 51 and the second sliding medium 52 may be independent structures that are fastened together and slide synchronously, or may be of an integrated structure, or may be independent structures that slide independently.

In some other embodiments, the first sliding medium 51 may include a first sliding sub-medium 5 and a second sliding sub-medium 5 that are disconnected in the second direction Y. The first sliding sub-medium 5 is provided with a first sliding sub-slot that fits the first phase-shift segment 31, and extends out of an end portion that is of the first sliding cavity 91 and that is close to the first phase-shift segment 31. The second sliding sub-medium 5 is provided with a second sliding sub-slot that fits the second phase-shift segment 32, and extends out of an end portion that is of the first sliding cavity 91 and that is close to the second phase-shift segment 32. Through the first sliding sub-medium 5 and the second sliding sub-medium 5, independent phase shift control on the first phase-shift segment 31 and the second phase-shift segment 32 can be implemented, and control is more flexible.

Similarly, the second sliding medium 52 may include a third sliding sub-medium 5 and a fourth sliding sub-medium 5 that are disconnected in the second direction Y. The third sliding sub-medium 5 is provided with a third sliding sub-slot that fits the third phase-shift segment 33, and extends out of an end portion that is of the second sliding cavity 92 and that is close to the third phase-shift segment 33. The fourth sliding sub-medium 5 is provided with a fourth sliding sub-slot that fits the fourth phase-shift segment 34, and extends out of an end portion that is of the second sliding cavity 92 and that is close to the fourth phase-shift segment 34. Through the third sliding sub-medium 5 and the fourth sliding sub-medium 5, independent phase shift control on the third phase-shift segment 33 and the fourth phase-shift segment 34 can be implemented, and control is more flexible.

An assembly process of the phase shifter 1 of the foregoing structure is as follows: The metal feed plate 3 is mounted on the fastening medium 4, the sliding medium 5 is placed on the fastening medium 4, and the phase-shift circuit extends into the sliding slot of the sliding medium 5. Then, the metal housing 6 is connected to the fastening medium 4, so that the mounting assembly 7 is integrally formed. After assembly of the mounting assembly 7 is completed, the metal housing 6 is mounted on and fastened to the carrier board 2.

It can be learned from the foregoing descriptions of the phase shifter 1 that, in the phase shifter 1 provided in this embodiment of this disclosure, the mounting assembly 7 is assembled based on only a structure design of the mounting assembly 7, and no additional fastening apparatus and connection piece is required. In addition, the mounting assembly 7 is fastened to and installed on the carrier board in a mounting and fastening manner, and no additional fastening apparatus and connection piece is required. Such a design is conducive to reducing a size of the mounting assembly 7 and implementing miniaturization of the mounting assembly 7, and is further conducive to reducing the size of the phase shifter 1 and implementing miniaturization of the phase shifter 1.

In the phase shifter 1 provided in this embodiment of this disclosure, the sliding medium 5, the metal housing 6, the metal feed plate 3, and the fastening medium 4 jointly form a stripline structure, which has an advantage of a small insertion loss compared with a PCB microstrip in a related technology. In addition, the fastening medium 4 has a high relative permittivity, which is conducive to reducing the size. In addition, the power division circuit and the phase-shift circuit can be integrated by using the metal feed plate 3, and integration is high. This facilitates miniaturization of the phase shifter 1.

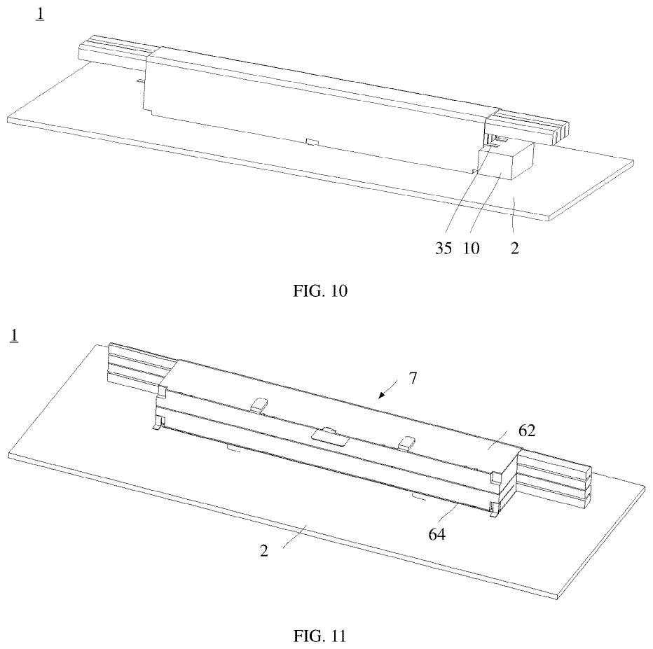

In the foregoing embodiments, the connection pin 35 is electrically connected to the second metal layer on the carrier board 2. However, embodiments of this disclosure are not limited thereto. For example, as shown in FIG. 10, the connection pin 35 may be suspended relative to the carrier board 2. In such a design, the connection pin 35 can be directly connected to the connection component 10, where the connection component 10 may be a connector, a filter, or the like. In this way, transfer performed by the carrier board 2 and a cable can be omitted, and a transmission loss can be reduced.

In the foregoing embodiments, the metal housing 6 is mounted on and fastened to the carrier board 2 through soldering of the first metal layer 22 and the end surfaces of the first side plate 62 and the second side plate 64. This assembly manner is defined as “normal installation” in this specification. However, embodiments of this disclosure are not limited thereto.

For example, as shown in FIG. 11, the metal housing 6 may be mounted on and fastened to the carrier board 2 in a side installation manner. That is, the metal housing 6 is mounted on the carrier board 2 through soldering of the first metal layer 22 and an outer side surface of the first side plate 62 or the second side plate 64.

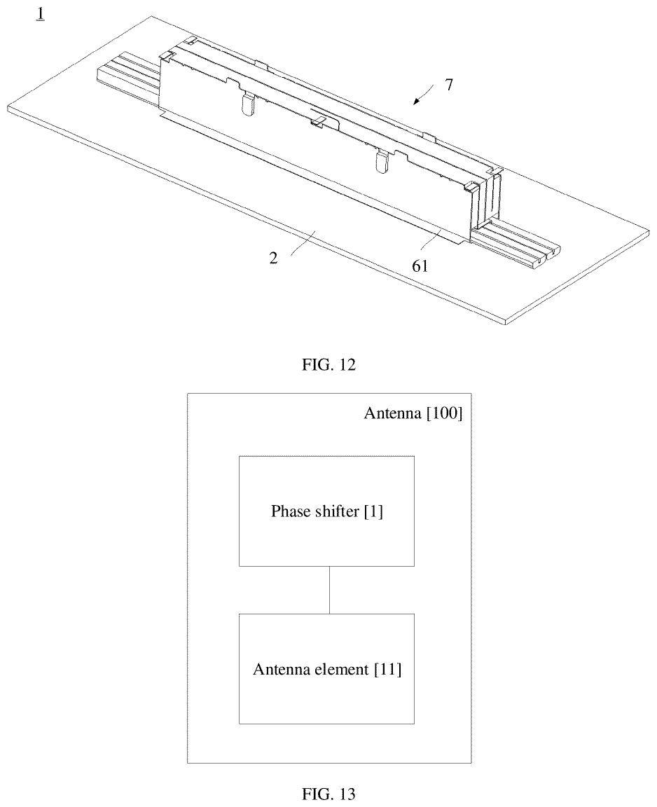

For another example, as shown in FIG. 12, the metal housing 6 may be mounted on and fastened to the carrier board 2 in an inverted installation manner. That is, the metal housing 6 is mounted on the carrier board 2 through soldering of the first metal layer 22 and an outer side surface that is of the connection plate 61 and that is away from the accommodating cavity 8.

In the foregoing embodiments, the solution is described by using an example in which mounting and fastening and electrical connection are implemented through soldering. However, embodiments of this disclosure are not limited thereto. For example, mounting and fastening and electrical connection may be alternatively implemented through conductive adhesive bonding.

An embodiment of this disclosure further provides an antenna. As shown in FIG. 13, the antenna 100 includes an antenna element 11 and the phase shifter 1 electrically connected to the antenna element 11. The antenna 100 may be used in a communication apparatus that requires an antenna, such as a communication base station or a radar.

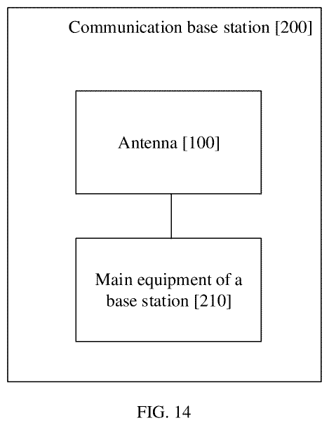

An embodiment of this disclosure further provides a communication base station. As shown in FIG. 14, the communication base station 200 includes main equipment of a base station 210 and the antenna 100 electrically connected to the main equipment of the base station 210. The main equipment of the base station 210 may include a baseband unit (Building Baseband Unit (BBU)) and a remote radio unit (RRU).

Technical effects that can be achieved by the antenna 100 and the communication base station 200 provided in embodiments of this disclosure are the same as technical effects that can be achieved by the phase shifter 1 in any one of the foregoing embodiments. Details are not described herein again.

The foregoing descriptions are merely embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A phase shifter, comprising:
a carrier board comprising a first metal layer disposed on one side;
a metal housing mounted on and fastened to a surface of the first metal layer, and is electrically connected to the first metal layer;
a fastening medium, fastened and mounted in the metal housing, wherein the metal housing and the fastening medium enclose a sliding cavity, and a relative permittivity of the fastening medium is greater than 1;
a sliding medium disposed in the sliding cavity, wherein the sliding medium is slidable relative to the fastening medium, and the sliding medium includes a sliding slot whose opening faces the fastening medium; and
a metal feed plate mounted on the fastening medium and comprises a phase-shift circuit extending into the sliding slot.

2. The phase shifter according to claim 1, wherein the metal housing is mounted on and fastened to the first metal layer through soldering or a conductive adhesive.

3. The phase shifter according to claim 1, wherein the metal housing includes a positioning pin protruding toward the carrier board; the carrier board includes a positioning hole that fits the positioning pin; and when the metal housing is mounted on and fastened to the first metal layer, the positioning pin extends into the positioning hole.

4. The phase shifter according to claim 1, wherein a portion of the metal housing in contact with the first metal layer and comprises a plurality of connection portions that are spaced apart and overflow notches located at edges of the plurality of connection portions, and the plurality of connection portions are mounted on and fastened to the first metal layer.

5. The phase shifter according to claim 1, wherein
the metal housing comprises a connection plate, a first side plate, and a second side plate, and the first side plate and the second side plate are disposed opposite to each other on a same side of the connection plate, and are separately connected to the connection plate; and
the fastening medium is located between the first side plate and the second side plate, and the first side plate and the second side plate are respectively connected to two side surfaces of the fastening medium.

6. The phase shifter according to claim 5, wherein
an outer side surface of the first side plate or an outer side surface of the second side plate is mounted on and fastened to the first metal layer; or
an outer side surface of the connection plate is mounted on and fastened to the first metal layer; or
end surfaces of the first side plate and the second side plate are away from the connection plate, and are mounted on and fastened to the first metal layer.

7. The phase shifter according to claim 5, wherein
end surfaces of the first side plate and the second side plate are away from the connection plate, and are mounted on and fastened to the first metal layer;
the first side plate and the second side plate each comprises a side plate end that is away from the connection plate and comprises a positioning pin protruding toward the carrier board, and the carrier board includes a positioning hole that fits the positioning pin; and
when the metal housing is mounted on and fastened to the first metal layer, the positioning pin extends into the positioning hole.

8. The phase shifter according to claim 5, wherein
end surfaces of the first side plate and the second side plate are away from the connection plate, and are mounted on and fastened to the first metal layer;
the first side plate and the second side plate each comprises a side plate end that is away from the connection plate and comprises a plurality of connection portions that are spaced apart in a length direction, and the plurality of connection portions are mounted on and fastened to the first metal layer; and
the side plate end further comprises overflow notches located at edges of the plurality of connection portions in the length direction.

9. The phase shifter according to claim 5, wherein
the first side plate and the second side plate further respectively comprise first and second limiting openings that run through the end surfaces that are of the first side plate and the second side plate, wherein the end surfaces of the first side plate and the second side plate are away from the connection plate, and the fastening medium includes first and second limiting protrusions; and
when the fastening medium is connected to the metal housing, the first and second limiting protrusions respectively extend into the first and second limiting openings.

10. The phase shifter according to claim 5, wherein
the metal housing further comprises an opening baffle disposed opposite to the connection plate, and connected to both the first side plate and the second side plate; and
the fastening medium is located on a side of the opening baffle that is close to the connection plate.

11. The phase shifter according to claim 5, wherein
the metal housing further comprises a partition plate connected to the connection plate, and the partition plate is located between the first side plate and the second side plate, and is parallel to the first side plate and the second side plate;
the fastening medium comprises a first fastening medium and a second fastening medium respectively located on two sides of the partition plate;
the sliding cavity comprises a first sliding cavity enclosed by the first fastening medium and the metal housing, and a second sliding cavity enclosed by the second fastening medium and the metal housing;
the sliding medium comprises a first sliding medium and a second sliding medium that are respectively located in the first sliding cavity and the second sliding cavity, the first sliding medium is slidable relative to the first fastening medium, the second sliding medium is slidable relative to the second fastening medium, the first sliding medium includes a first sliding slot whose opening faces the first fastening medium, and the second sliding medium includes a second sliding slot whose opening faces the second fastening medium; and
the metal feed plate further comprises a first circuit portion and a second circuit portion that are respectively located on the two sides of the partition plate, the first circuit portion is installed on the first fastening medium and comprises a phase-shift circuit extending into the first sliding slot, and the second circuit portion is installed on the second fastening medium and comprises a phase-shift circuit extending into the second sliding slot.

12. The phase shifter according to claim 11, wherein
the metal feed plate further comprises an intercavity circuit portion that connects the first circuit portion and the second circuit portion; and
the partition plate includes an intercavity window that allows the intercavity circuit portion to pass through.

13. The phase shifter according to claim 11, wherein
the first circuit portion comprises at least two phase-shift circuits extending into the first sliding slot; or
the second circuit portion comprises at least two phase-shift circuits extending into the second sliding slot.

14. The phase shifter according to claim 1, wherein the metal feed plate comprises the phase-shift circuit and a power division circuit.

15. The phase shifter according to claim 1, wherein
the metal feed plate comprises a connection pin electrically connected to a second metal layer on the carrier board; or
the connection pin is suspended relative to the carrier board.

16. The phase shifter according to claim 1, wherein the metal feed plate is a sheet metal stripline.

17. The phase shifter according to claim 1, wherein the metal housing is a sheet metal mechanical part.

18. An antenna comprising:
an antenna element; and
a phase shifter comprising:
a carrier board comprising a first metal layer disposed on one side;
a metal housing mounted on and fastened to a surface of the first metal layer, and is electrically connected to the first metal layer;
a fastening medium fastened and mounted in the metal housing, wherein the metal housing and the fastening medium enclose a sliding cavity, and a relative permittivity of the fastening medium is greater than 1;
a sliding medium disposed in the sliding cavity, wherein the sliding medium is slidable relative to the fastening medium, and the sliding medium includes a sliding slot whose opening faces the fastening medium; and
a metal feed plate mounted on the fastening medium and comprises a phase-shift circuit extending into the sliding slot;
wherein the antenna element is electrically connected to the phase shifter.

19. A communication base station, comprising:
an antenna comprising an antenna element and a phase shifter electrically connected to the antenna element;
wherein the the phase shifter comprises:
a carrier board comprising a first metal layer disposed on one side;
a metal housing mounted on and fastened to a surface of the first metal layer, and is electrically connected to the first metal layer;
a fastening medium fastened and mounted in the metal housing, wherein the metal housing and the fastening medium enclose a sliding cavity, and a relative permittivity of the fastening medium is greater than 1;
a sliding medium disposed in the sliding cavity, wherein the sliding medium is slidable relative to the fastening medium, and the sliding medium includes a sliding slot whose opening faces the fastening medium; and
a metal feed plate mounted on the fastening medium and comprises a phase-shift circuit extending into the sliding slot;
wherein main equipment of the communication base station is electrically connected to the antenna.
